(19) United States
(12) Patent Application Publication
(10) Pub. No.: US 2007/0246402 A1
(43) Pub. Date: Oct. 25, 2007

(54) Method for recognizing an item of mailing data

(75) Inventors: Peter Schumm, Ottoberg (CH); Klaus Vollmann, Konstanz (DE)

Correspondence Address: SIEMENS SCHWEIZ AG;I-47, INTELLECTUAL PROPERTY, ALBISRIEDERSTRASSE 245, ZURICH, CH-8047, omitted

(73) Assignee: SIEMENS AKTIENGESELLSCHAFT, MUNICH (DE)

(21) Appl. No.: 11/732,916

(22) Filed: Apr. 5, 2007

(30) Foreign Application Priority Data
Apr. 6, 2006 (DE) 10 2006 016 602.7

(51) Int. Cl. B03B 13/00

(52) U.S. Cl. 209/1

(57) ABSTRACT

In a method for recognizing a graphical item of mailing data on mailed items which are to be mechanically sorted, an image of a mailed item is recorded and encoded using gray values. The recorded image is digitized in binary form in accordance with a variable threshold characteristic curve, so that at least one item of mailing data is recognized for sorting the mailed item. In the event of incomplete recognition of the item of mailing data, the recorded image is digitized using a reset threshold characteristic curve. After a predefined number of incomplete recognitions, manual sorting is initiated.

### BACKGROUND OF THE INVENTION

The present invention relates to a method for recognizing an item of mailing data.

For video encoding of images of mailed items, e.g., at the input to a high-speed sorting facility in a post office, for example, the objective is to recognize as quickly as possible the correct items of data—address, barcode etc.—from all the images used for this purpose, so that they can be used subsequently in legible form.

For the largest number of mailed items, this can be most efficiently achieved if the image is encoded and displayed as a binary image, using a suitable binary coding characteristic curve, so that when it is visualized the useful data (e.g., the address) stands out on the background with a good contrast. However, with some images it can happen that the required data is no longer visible on the binary coded image, because for a given binary encoding characteristic curve the print color of the image is too light or the background too dark. In the first case, the image can be completely white, in the other case completely black.

Another possibility consists in encoding the data for the mailed item as a gray image (i.e., with several grayscale values). In this case, more items of data can be seen than with a binary image, but unless the print color differs strongly from the background color the video encoder requires more work and time to recognize the data than in the case of a binary image.

### SUMMARY OF THE INVENTION

The objective underlying the invention is to ensure the efficient mechanized sorting of mailed items on the basis of their mailing data.

Accordingly, starting from a method for recognizing a graphical item of mailing data for mailed items which are to be sorted mechanically, the item of mailing data is first encoded using grayscales, and is then digitized in binary form according to a variable threshold characteristic curve, so that for the purpose of sorting at least one item of delivery data is recognized. In the case the item of mailing data is incompletely recognized—i.e., for a possible visualization—a further binary encoding is carried out with a reset threshold characteristic curve and, after a predefined number of incomplete recognitions, manual sorting is initiated.

The objective of this operation is that after a defined time or a predefined number of attempts at digitization the data should be accessed as quickly as possible. For example, after five attempts an operator at the sorting facility will forgo binary encoding and fall back on encoding using grayscales. In doing so the operator knows in addition that it may be necessary to check the data for some mailed items manually, because it was impossible to recognize it after all attempts. The method in accordance with the invention allows a more flexible recognition of easily accessible items of postal data (by means, e.g., of 2-3 attempts) together with more efficient recognition of postal data which remains persistently unclear (no improvement after 5 attempts, for example, because of missing or hard-to-read data inputs for mailed items).

In practice, after visualization of a first digitization a further digitization, i.e., another attempt at digitization, is initiated manually, preferably at the press of a button. This operation will be repeated at most according to the predefined number of the attempts at digitization. An alternative modification of the digitization can be carried out using an analog regulator, such as a slide regulator.

A region of the mailed item or the item of mailing data can also be encoded, and digitized in binary form in accordance with the invention. Before doing so, the region can be detected with the help of a facility for recognizing important data. Other regions can be ignored or if necessary be left as gray images. In this way, only a few items of data for the mailed item need be digitized.

The variable threshold characteristic curve for binary encoding can be selected in steps, and from it dark and light digitized regions of the mailed item can be determined, provided that the two regions produce a predefined density ratio for the encoding type or a pattern which is clear to the operator. The predefined density ratio or pattern can, for example be preset at the post office by typical letter templates or their data pattern, so that after one or more preset digitization operations the complete data is recognized. By this means, a high proportion of mailed items can be efficiently sorted.

In cases where an item of mailing data still remains incompletely recognized, these residual postal items can be fed to a manual sorting point. There they are more closely investigated by an operator. What is important is that by the method in accordance with the invention, fewer of the mailed items which are incompletely recognized after a single digitization procedure are immediately fed to the manual sorting point, because at least a limited number of further attempts at digitization will be initiated to improve the legibility of, for example, house numbers and zip/post codes.

The number of attempts at digitization could also be unlimited, but it should be adjusted appropriately for the normal high throughput of the sorting facility.

Advantageous embodiments of the invention are explained in the subclaims.

### BRIEF DESCRIPTION OF THE DRAWINGS

These and other aspects, advantages and novel features of the embodiments described herein will become apparent upon reading the following detailed description and upon reference to the accompanying single drawing. In the following:

FIG. 1 shows a sorting facility for mailed items with recognition of encoded items of mailing data.

### DETAILED DESCRIPTION OF CERTAIN INVENTION EMBODIMENTS

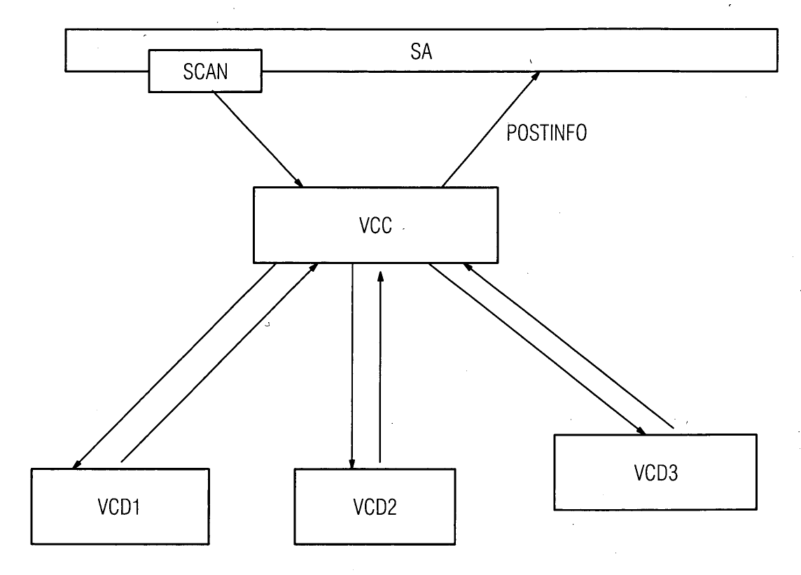

FIG. 1 shows a sorting facility SA for mailed items—e.g., with one or more letter sorting machines—with recognition of appropriate encoded items of mailing data. This recognition is effected by an image management system, which has a control unit VCC and one or more video encoding units VCD1, VCD2, . . . .

For a mailed item in the sorting facility SA, a scanner SCAN, in accordance with the invention, records an image of the mailed item with, for example, 256 encoded gray values. Further, on the video encoding unit VCD1 the image recorded is digitized in binary form (black/white) and displayed. When doing this, a first binary characteristic curve is set.

In FIG. 1, the arrows from the scanner SCAN to the control unit VCC and from the control unit VCC to the video encoding units VCD1, VCD2, . . . show the flow of the digital gray image, which may possibly be enhanced, taking into account the binary encoding characteristic curve to be used in the first pass).

The arrows from the video encoding units VCD1, VCD2, . . . to the control unit VCC show the flow of the data input to a video encoding unit VCD1, VCD2, . . . . This contains items of address data and possibly an amended binary encoding characteristic curve.

The arrow from the control unit VCC to the sorting facility SA shows the flow of the data relevant for sorting, which the control unit VCC has derived from the items of address data from the video encoding units VCD1, VCD2, . . . .

If the item of mailing data is not recognizable at this point, a new binary characteristic curve is selected by the pressing of a button on the first video encoding unit VCD1, and the image is redisplayed. This is repeated until the desired item of data is recognizable, or the video encoding unit VCD1, VCD2, . . . decides on the display of the gray image. If the desired item of data is recognizable, then the video encoding unit VCD1, VCD2, . . . inputs the item of data required for the first recognition step (e.g., the post/zip code).

After this, the image of the mailed item may be passed by the control unit VCC to another video encoding unit VCD1, VCD2, . . . for a further processing step (e.g., the recognition of the street data). There, the image of the mailed item is initially displayed with the setting used in the preceding processing step (i.e., using the binary encoding characteristic curve with which the item of data was successfully recognized). Since the relevant items of data are generally printed in the same color on the same background, this setting should in many cases be suitable for the recognition of the further data items (for example, for the street data), and this data can be easily recognized and input with no additional work.

The same applies for any further processing steps (e.g., selection of a possible recipient on a video encoding unit VCD3).

The video encoding stations VCD1, VCD2, . . . can be realized as one single unit, which is linked to the scanner SCAN via the control unit VCC.

We claim:

1. A method for recognizing a graphical item of mailing data on mailed items which are to be mechanically sorted, comprising:
recording an image of a mailed item;
encoding the recorded image using gray values;
digitizing the recorded image in binary form in accordance with a variable threshold characteristic curve, so that at least one item of mailing data is recognized for sorting the mailed item;
in the event of incomplete recognition of the item of mailing data, digitizing the recorded image using a reset threshold characteristic curve; and,
after a predefined number of incomplete recognitions, initiating manual sorting.

2. The method of claim 1, further comprising, after a visualization of a first digitization, activating subsequent digitizations manually.

3. The method of claim 1, further comprising selecting the variable threshold characteristic curve in steps; and determining from the variable threshold characteristic curve dark and light digitized regions of the mailed item, provided that the two regions form a predefined density ratio.

4. The method of claim 1, wherein setting of the variable threshold characteristic curve is effected in accordance with a range of known formats for one of mailed items and items of mailing data.

5. The method of claim 1, wherein after a predefined number of incomplete recognitions, gray values are used again for manual recognition.

6. The method of claim 1, wherein at least one region of the mailing data is encoded.

7. The method of claim 1, wherein at least one region is digitized in binary form, when one region of the mailing data remains encoded by gray values.

8. The method of claim 1, wherein at least one region of the mailing data is encoded and digitized in binary form.
